(19) United States
(12) Patent Application Publication
(10) Pub. No.: US 2022/0012000 A1
(43) Pub. Date: Jan. 13, 2022

(54) VISUALLY ASSISTED MULTI-DISPLAY CONFIGURATION

(71) Applicant: Intel Corporation, Santa Clara, CA (US)

(72) Inventors: Rupesh Thyagarajan, Folsom, CA (US); Yatin V. Gambhir, Portland, OR (US); Vishaal Nagaraja, Folsom, CA (US)

(21) Appl. No.: 17/485,266

(22) Filed: Sep. 24, 2021

(51) Int. Cl. G06F 3/147; G09G 5/14; G06T 7/73; G06T 7/13; G06K 7/14

(52) U.S. Cl. CPC G06F 3/147; G09G 5/14; G06T 7/73; G06T 2207/10004; G06K 7/1417; G09G 2370/042; G09G 2370/18; G06T 7/13

(57) ABSTRACT

Methods and systems for automatic or semi-automatic configuration of an array of multiple monitors are disclosed. In various embodiments, a computer system attached to a plurality of monitors causes each of the monitors to display a unique identifier. A picture is then captured of the physical layout of the plurality of monitors, which is analyzed to detect monitor edges and extract the unique identifier displayed on each monitor. The detected edges and extracted identifiers are then used to determine the physical layout of the plurality of monitors, which is then provided back to the computer system for appropriate configuration. The unique identifier may also convey monitor information such as resolution, to allow the operating system to set various parameters such as font scaling.

### TECHNICAL FIELD

Disclosed embodiments are directed to techniques for configuration multiple displays, and in particular to methods and systems for automatically detecting the arrangement of multiple displays using an external camera.

### BACKGROUND

Computer systems are increasingly used with a variety of different display configurations. While some systems may be configured with a single large, high resolution display, other systems are equipped with two, three, or even more separate monitors. Depending upon the intended usage of a given computer system, multiple monitors may be configured to mirror each other, i.e. each monitor displays identical content, or may be configured to display different content, such as one monitor displaying a presentation slide with a second monitor displaying a control panel for the presentation, or each monitor displaying distinct desktop area so that multiple running applications can be distributed across multiple displays. When appropriately configured, multiple displays can be treated by the computer as a single, aggregate display, such as a wall of monitors in a tiled configuration acting as a single large monitor.

The background description provided herein is for the purpose of generally presenting the context of the disclosure. Unless otherwise indicated herein, the materials described in this section are not prior art to the claims in this application and are not admitted to be prior art by inclusion in this section.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a flowchart of an example method for determining the physical layout of multiple displays from an image, according to various embodiments.

FIG. 2 is a flowchart of an example method for processing the physical layout of multiple displays detected from an image, according to various embodiments.

FIG. 3 depicts an example system for capturing an image of a physical monitor layout and providing the layout to a computer system attached to the physical monitors, according to various embodiments.

FIG. 4A depicts an example monitor layout as may be understood by a computer system prior to capture and processing of an image of the monitor layout, according to various embodiments.

FIG. 4B depicts the monitor layout of FIG. 4A understood by the computer system after processing of the image of the monitor layout, according to various embodiments.

FIG. 5 depicts an example monitor layout with each of the monitors displaying an example unique code, according to various embodiments.

FIG. 6 is a block diagram of an example computer that can be used to implement some or all of the components of the system of FIG. 1, according to various embodiments.

FIG. 7 is a block diagram of a computer-readable storage medium that can be used to implement some of the components of the system or methods disclosed herein, according to various embodiments.

### DETAILED DESCRIPTION

Depending upon how multiple monitors are to be utilized, the computer system to which they are attached may need to be instructed as to the physical layout of the monitors. If a pair of monitors are mirrored, e.g. each monitor displays identical contents, then the physical layout of the pair of monitors is typically immaterial. Conversely, if a pair of monitors each displays a distinct portion of a desktop, e.g. the operating system desktop is extended across both screens, then the physical layout of the monitors takes on significance. For example, if each monitor contains half of the operating system desktop where a user can move the mouse cursor and application windows between monitors by dragging, it is preferable that the desktop follow the physical layout of the monitors. Where the desktop is to span horizontally, the left side of the desktop is preferably placed on a left hand monitor, and the right side of the desktop placed on a right hand monitor. In such a configuration, moving and dragging between monitors physically corresponds to the monitor layout. If the desktop configuration does not correspond to the physical monitor layout, undesirable behavior may result, such as having to move the mouse to the left to reach the right hand screen, which is counterintuitive to the behavior suggested by the monitor layout. Furthermore, where an operating system is configured to display a single image across multiple screens, the image may be effectively scrambled if the monitor layout expected by the computer does not align with the physical monitor layout.

Most modern operating systems include a control panel, setting, configuration tool, or some other facility for informing the operating system about the physical layout of multiple monitors that may be connected to the computer system. Depending upon the specifics of a given implementation, such facilities may include representative images of each connected monitor. The representative images may indicate the operating system's understanding of each monitor's resolution relative to the other monitors, each monitor's orientation, e.g. landscape or portrait, and, importantly, the operating system's understanding of each monitor's position relative to the other monitors. Based on this understanding, the operating system determines which monitor to direct various parts of the display information, e.g. which part of the desktop should map to which monitor, which monitor is considered primary vs. secondary for applications that may display different information on different monitors, etc.

In some such implementations, it is up to the user of the computer to manipulate the facility or tool such that the configuration understood by the operating system matches the physical configuration of the monitors. How this is accomplished varies depending upon the specific implementation employed by a given operating system. In some examples, the facility or tool may provide a graphic depiction of the connected monitors, which can be dragged about into an arrangement that approximates the physical layout of the monitors. Options may further be provided to the user to indicate how the monitors are to be employed, e.g. whether they will be used to mirror content from one selected monitor, whether a monitor may be used as an auxiliary monitor for certain applications, whether the operating system desktop will be spread across all monitors, which monitor may be the primary monitor, etc. Some facilities may further offer assistance, such as an identification option where the operating system may cause each monitor to display a number or letter that corresponds to the graphical depiction in the facility, to help the user assure that they have arranged the monitors correctly to match their physical layout.

Such a facility or tool has the drawback of adding complexity to setting up a computer system. The process of setup may be off-putting for inexperienced users even as the prevalence of multiple monitor setups increases, and time-consuming for experienced users. Depending upon how a particular facility or tool is implemented, setup may require a degree of trial and error. One possible solution is to equip monitors with hardware sensors that allow each monitor to detect the presence and orientation of adjacent monitors, and then feed this information back to the computer system, which can then automatically generate a monitor layout that reflects the physical layout. However, such an approach requires either retrofitting existing monitors with appropriate sensor technology, or investing in monitors that are already equipped with such sensor technology; it does not work with existing or legacy monitors that lack appropriate sensors. Furthermore, the operating system must also support such technology, such as with dedicated device drivers or software that must be installed. Thus, such a solution may present its own set of complexities that equal or exceed manual configuration, as well as impose the additional expense of investing in new monitors equipped with sensor technology, or the time and money of having to retrofit existing monitors with appropriate sensors.

Disclosed embodiments include systems and methods for providing automatic configuration of multiple monitor arrangements that does not require special hardware, and works with existing monitor technology. In some embodiments, software causes a unique visual code, such as a QR code, to be displayed on each monitor. The code displayed on each monitor may convey both the orientation of the monitor (e.g. landscape or portrait), as well as monitor information such as make, model, size, and resolution. Each code is readable by a device with a camera, which can pass a captured image back to the software for processing and determining the monitor layout. The device may be a smartphone, tablet, webcam, or another suitable device that can capture all monitors simultaneously as they display their unique codes, so that the arrangement of monitors may be inferred from the relative positions and orientations of each of the codes. This image can then be processed to yield the physical configuration of the monitors, which may then be provided to the operating system for appropriate configuration. Other possible embodiments will be discussed herein.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

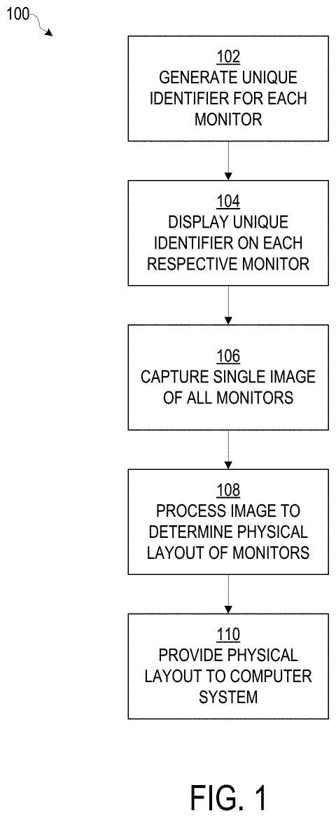

FIG. 1 illustrates an example method 100 for detecting the physical layout of a plurality of monitors connected to a computer system, and then providing that detected layout to the computer system. Depending on the particulars of a given implementation, the operations of method 100 may each be carried out in whole or in part, may be omitted, or may be carried out in a different order than depicted. Other operations may be performed in addition to the listed operations, or in lieu of one or more operations.

In operation 102, the computer system to which each of the plurality of monitors is attached generates a unique identifier or code for each monitor of the plurality of monitors. In the depicted embodiment, the computer system is aware of each monitor connected to it, but is not aware of the physical location of each monitor relative to the other attached monitors. The unique identifier allows each particular monitor to be specifically identified out of the plurality of monitors. Depending upon the embodiment, the unique identifier may convey other information besides uniquely identifying its respective monitor, such as monitor orientation and monitor attributes such as native resolution, current display resolution, make/model, size, etc. The unique identifier will be discussed further herein. The data may be encoded by the unique identifier and/or the identifier may act as a reference to allow various monitor attributes to be looked up or otherwise retrieved, such as from an online database.

Following generation of the unique identifier, in operation 104, the computer system causes each of the plurality of monitors to display its associated unique identifier. How each monitor is to display each identifier may depend upon the nature of each monitor and/or the nature of the unique identifier, such as the type and format of the identifier. For example, some embodiments may display the identifier in a window, while other embodiments may overlay the identifier over existing screen content, or may blank the screen so that only the unique identifier is displayed. In embodiments, each identifier is displayed on each monitor at a sufficiently large size so as to be readable by a device that is capturing a picture of the entire layout of the plurality of monitors in a single capture.

The actual size necessary to be readable may depend on several different factors, such as monitor size, monitor resolution, camera resolution of the device capturing the picture of the monitor layout, and distance from the plurality of monitors necessary to achieve a capture of all monitors. In some embodiments, each unique identifier may be rendered to fill up all, or substantially all, of its monitor's screen, to maximize the readability of each unique identifier from the picture of the monitor layout. In other embodiments, the computer system may allow the size of one or more of the unique identifiers to be scaled to a suitable size, or may work in concert with a feed from the capturing device to automatically scale each unique identifier until it is readable. Further, the computer system may temporarily override any display settings such as resolution, contrast, brightness, tint, color temperature, and color saturation to ensure that each unique identifier is displayed with optimal readability. It should further be understood that how each identifier is displayed may depend upon the type and format of the unique identifier, e.g. QR code or another code that encodes in two dimensions, bar code, whether the code is monochromatic or in color, etc.

Next, a single image is captured of the physical layout of the plurality of monitors, in operation 106. The single image should capture all monitors coupled to the computer system that are subject to automatic configuration, with each of the monitors displaying its respective unique identifier. The capturing device may be a camera, such as an RGB camera that may be found in a typical mobile device, for capturing the single image. The capturing device, in embodiments, captures an image of sufficient resolution that the unique identifier on all monitors is readable by an image processing algorithm that can extract the information encoded into each unique identifier. A sufficient resolution may depend upon the overall size of the physical layout of the plurality of monitors as well as the size and resolution of each of the monitors in the plurality of monitors. Thus, a physically expansive arrangement of multiple monitors, such as where several monitors are arranged linearly, may require backing to a suitable distance or employing a sufficiently wide angle lens so that all monitors can be captured in a single shot, provided the camera itself is of sufficient resolution that the unique identifier on each monitor can be decoded. Alternatively, where the capturing device cannot be positioned back to capture all monitors in a single shot with sufficient clarity or where space constraints prevent moving the camera back far enough to capture all monitors, multiple shots may be employed with a stitching algorithm to create a single panoramic capture. As is known, some capturing devices are equipped with software to automatically create such a panoramic image, where multiple captures result in a single image with dimensions greater than may be achieved with a single capture.

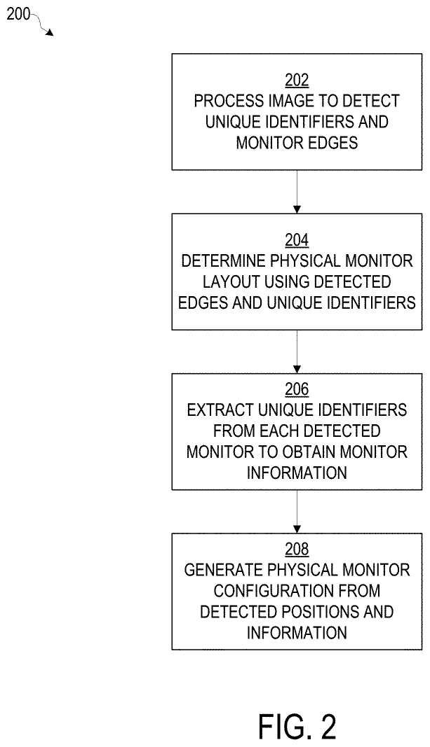

In operation 108, the captured single image is processed to determine the physical layout. This processing may include both extraction and decoding of the various unique identifiers for each monitor, as well as possible object or edge detection to better determine the physical arrangement of the monitors. The operations involved in processing the image and ascertaining the physical monitor layout will be discussed in greater detail with respect to FIG. 2.

Once the physical layout of the monitors has been detected and determined, in operation 110 this physical layout is provided back to the computer system to which the monitors are attached. The provided physical layout may then be used by the computer system to automatically establish a monitor configuration by the computer system's display configuration tool, if so equipped. For example, where the computer system is running Microsoft® Windows®, the Display control panel in the operating system settings may be provided with the detected physical layout, so that the operating system can allow content to be correctly placed and manipulated across the multiple displays. Depending on the information provided in each unique identifier and the particulars of a given embodiment, the control panel may also be prepopulated with display settings such as preferred resolution and/or display scaling. In some embodiments, a user of the computer system may be able to use the detected physical layout to further customize the display behavior, but without the need to manually inform the operating system of the physical monitor layout and/or additional monitor attributes. As will be understood by a person skilled in the art, other operating systems may have similar tools. Depending on the particulars of a given embodiment, the user of the computer system may need to inform the device or system that provides the physical layout of the type of operating system running on the computer system, so that the physical layout data can be provided in an appropriate and compatible format.

While method 100 and the example embodiments discussed herein assume that the plurality of monitors encompasses all of the monitors attached to the computer system, it should be understood that method 100 could be used with a subset of all monitors attached to the computer system. When so implemented, the control panel or other display configuration tool of the computer system operating system may only reflect the physical layout of the monitors captured and detected in the single image. Additional monitors attached to the computer system that are not found within the single image may be displayed in a generic fashion, or otherwise may not reflect their actual physical position relative to the detected subset plurality of monitors.

FIG. 2 illustrates an example method 200 for processing an image of a physical layout of a plurality of monitors, and providing the detected layout to the computer system to which the plurality of monitors is connected. Depending on the particulars of a given implementation, the operations of method 100 may each be carried out in whole or in part, may be omitted, or may be carried out in a different order than depicted. Other operations may be performed in addition to the listed operations, or in lieu of one or more operations. As discussed above, method 200 may entail operations performed as part of operation 108.

In operation 202 of the example embodiment, the captured image of the physical layout of the plurality of monitors is processed to detect the unique identifiers displayed on each of the monitors, as well as the edges of each of the monitors. Any suitable algorithm may be used to detect the unique identifiers and/or edges. The selection of algorithm to detect each of the unique identifiers may depend upon the nature of the identifier, e.g. where implemented using a QR code, known libraries and algorithms may be used for both detection and decoding of each unique identifier, with a separate algorithm employed for monitor edge detection. Other types of identifiers may employ different algorithms. For edge detection of the monitors, a suitable edge detection algorithm, such as is known or may be later developed, may be employed. In some implementations, a single algorithm may be suited to both detection of the unique identifiers as well as monitor edges, with a second algorithm employed to decode the detected unique identifiers. In other implementations, a single algorithm or library may be capable of handling all detection and decoding. In still other implementations, multiple algorithms may be used for detection of the unique identifiers, decoding of the same, and detection of the monitor edges.

Next, in operation 204 of the example method, the detected unique identifiers and locations and dimensions of detected monitor edges may be used to determine the physical layout of the plurality of monitors. Any suitable algorithm now known or later developed in image processing may be employed for determining the physical layout. The physical layout of the plurality of monitors may be expressed relative to some suitable reference point, such as the 0, 0 coordinate of the image of the physical monitor layout that was processed in operation 202. In some embodiments, the physical layout of the monitors may be determined solely by reference to the detected unique identifiers, as each unique identifier can be correlated to a particular monitor in the plurality of monitors, and the position of each unique identifier can be ascertained relative to the other unique identifiers. For example, the image of the plurality of monitors may not be taken in sufficient light to allow the edges of each of the plurality of monitors to be reliably distinguished from the image background. However, the relative position of each of the unique identifiers relative to each other may be determined as part of the process of identifying and decoding each of the unique identifiers. In some embodiments, the position of each of the unique identifiers relative to each other may be sufficient to determine the physical monitor layout. Each of the unique identifiers may further encode sufficient information that the physical dimensions of their respective monitors can be inferred.

In operation 206, monitor information may be extracted from each of the unique identifiers. Depending upon the content of the extracted information, the information may be used to help determine the relative position of each monitor as well as each monitor's orientation, as discussed above in connection with operation 204. In addition to the relative position of each of the unique identifiers relative to each other, the unique identifiers may provide model information for each of the monitors, which can then be used to look up the physical parameters of each monitor, e.g. dimensions, native resolution, current resolution, etc. With this additional information, in addition to calculating the physical layout of the monitors, other factors such as optimal resolution and display scaling can be provided to the operating system. For example, where a particular layout is essentially a wall of monitors of disparate types that are to behave as a single monitor, resolution information encoded into each unique identifier may allow the computer operating system to set an appropriate scaling factor for each monitor to enable the plurality of monitors to be used relatively seamlessly as a single, large display. For another example, the monitor information may be used by the operating system to set font scaling for each monitor so that font sizes remain relatively consistent across the plurality of monitors, even when the monitors have differing resolutions and/or pixel pitches (e.g., a 24″ monitor with a native resolution of 1920×1080 will have a smaller pixel pitch than a 27″ monitor with an identical native resolution).

In operation 208, finally, a configuration for the physical monitors is generated from the detected physical monitor layout and, optionally, any information encoded into the unique identifiers. The format of the configuration information, as discussed above with respect to operation 110 of method 100, may depend upon the operating system running on the computer system connected to the plurality of monitors. Furthermore, information such as scaling may be calculated in operation 208, in some embodiments, or the raw information extracted from each unique identifier may simply be passed on to the operating system in other embodiments. The determination of information to calculate may be made in part based upon user input, such as whether the user indicates a desire that all displays have approximately equal font sizes or an indicated intended use of the configuration. In some embodiments, the user may indicate these uses directly to the operating system, such that only the physical monitor layout needs to be computed, with any additional information simply passed on to the operating system.

Following generation of the configuration of the physical monitors and provision to the computer system, the computer system may use the layout to coordinate display of images, such as various operating system elements, applications, windows, etc. An operating system desktop may be spanned across the plurality of monitors as a user may see fit. Further, the plurality of monitors may be used to display a single image or collection of images across multiple monitors, which may act partially or wholly as a single, large, collective display.

It should be understood that, because operating systems typically are only concerned with relative monitor positioning, the absolute location of each of the plurality of monitors within the captured image is not typically relevant. Rather, the position of each of the plurality of monitors with respect to each other only needs to be ascertained, and so the position of each of the plurality of monitors may be expressed with respect to some arbitrarily selected point, or to some reference point that will be understood by the operating system display configuration tool. The particular information needed will depend on the specific operating system being used with the computer system.

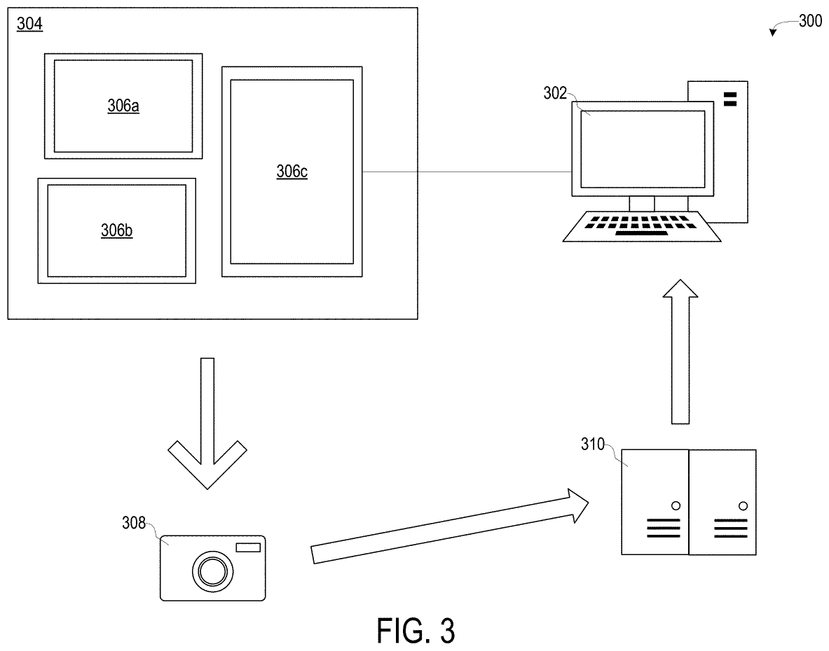

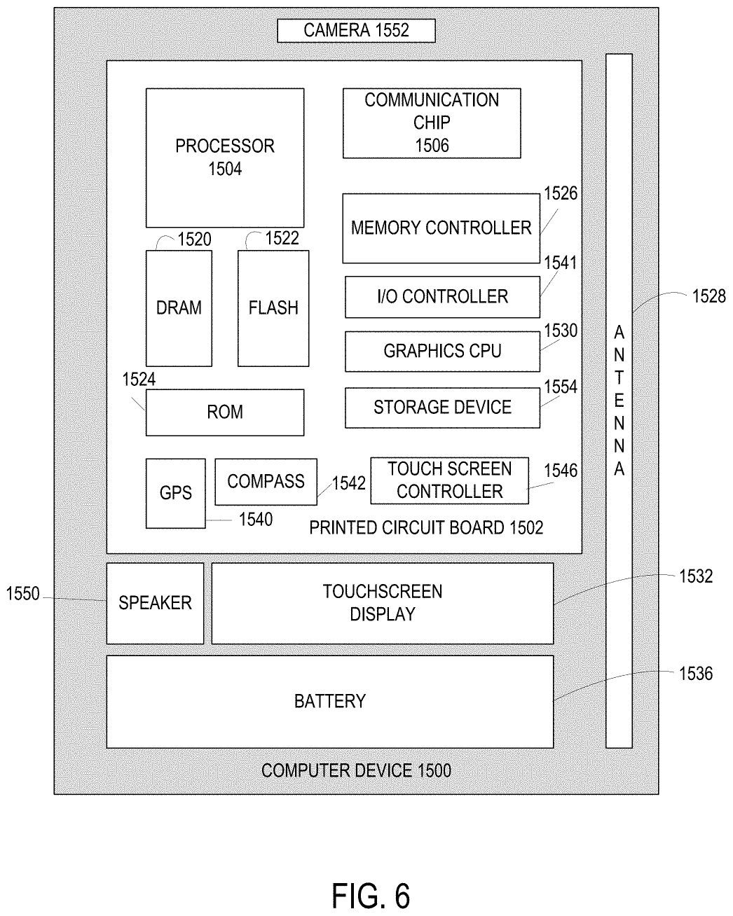

FIG. 3 illustrates an example system 300 that can be used to implement example methods 100 and 200, according to some embodiments. System 300 includes a computer system 302, which in turn may be connected to a plurality of monitors 304. Computer system 302 may, in embodiments, be a computer device 1500, discussed herein with respect to FIG. 6. Plurality of monitors 304 is comprised of monitors 306a, 306b, and 306c, in the depicted example. It should be understood that the three monitors 306a, 306b, and 306c of plurality of monitors 304 is for illustrative purposes only, and other configurations may have more or fewer monitors. The orientation and size of each of the monitors 306a, 306b, and 306c may be arbitrary, with all monitors being identical, or monitors of different makes, models, and sizes being present, potentially in different orientations, e.g. some may be landscape oriented, such as monitors 306a and 306b, and some in a portrait orientation, such as monitor 306c. Computer system 302 acts to drive the plurality of monitors 304 in accordance with the display settings on an operating system running on computer system 302.

Each monitor in the plurality of monitors 304 may be connected to the computer system 302 in any suitable fashion, e.g., via a hard connection such as composite, S-Video, VGA, HDMI, Display Port, DVI, USB, Thunderbolt, or another suitable connection technology that is currently used or later developed. Alternatively or additionally, one or more of the plurality of monitors may be connected to the computer system 302 wirelessly, using WiFi, Bluetooth, NFC, UWB, or another suitable wireless communications protocol. In some embodiments, one or more of the monitors may be connected by a combination of wired and wireless protocols. Some monitors may be connected via an intermediary device, such as a casting device.

A capture device 308, such as a camera or camera-equipped device like a smartphone, tablet, mobile device, web cam, or a similar such device, is used to capture a single image of the plurality of monitors 304 that captures a picture of each of monitors 306a, 306b, and 306c in a single frame. As discussed above, the single image may be captured as a single frame by capture device 308, if equipped with a suitably high resolution camera, or may be constructed by stitching together a series of captures to provide a suitably high resolution image. As discussed above with respect to method 100, the resulting image needs to be of sufficient resolution so that at least the unique identifiers displayed on each of the monitors 306a, 306b, and 306c can be decoded.

The capture device 308 may be in data or network communication with a remote system 310. Remote system 310 may be a cloud service or other remote server or processor that is in communication both with capture device 308 and computer system 302. Remote system 310 may communicate with capture device 308 and/or computer system 302 over any suitable network technology, such as a local area network, direct connection, or over the Internet, such as when remote system 310 is implemented as a cloud service. In the depicted embodiment, the remote system 310 handles the processing of images from capture device 308 to generate the physical layout of the plurality of monitors. In such an embodiment, remote system 310 may implement some or all of method 200/operation 108 of method 100. As shown in FIG. 3, remote system 310 is in data communication with computer system 302, and so provides the resulting physical layout to computer system 302 in response to receiving an image of the physical monitor layout from capture device 308. Capture device 308 may communicate with central server 310, and central server 310 may communication with computer system 302, over wired or wireless networks, or some combination of both.

While FIG. 3 illustrates an embodiment where a remote system 310 calculates the physical layout, in other embodiments capture device 308 may handle some or all of the calculation of the physical layout, such as by implementing some or all of operations 106, 108, and 110 of method 100, and some or all operations of method 200. In such an embodiment, capture device 308 may be in direct communication with computer system 302 rather than in communication with a remote system 310. Alternatively, computer system 302 may implement some or all of operations 108 and 110, and some or all operations of method 200, with capture device 308 only providing the image of the physical monitor layout directly to computer system 302. In any of such embodiments, a remote system 310 may be unnecessary.

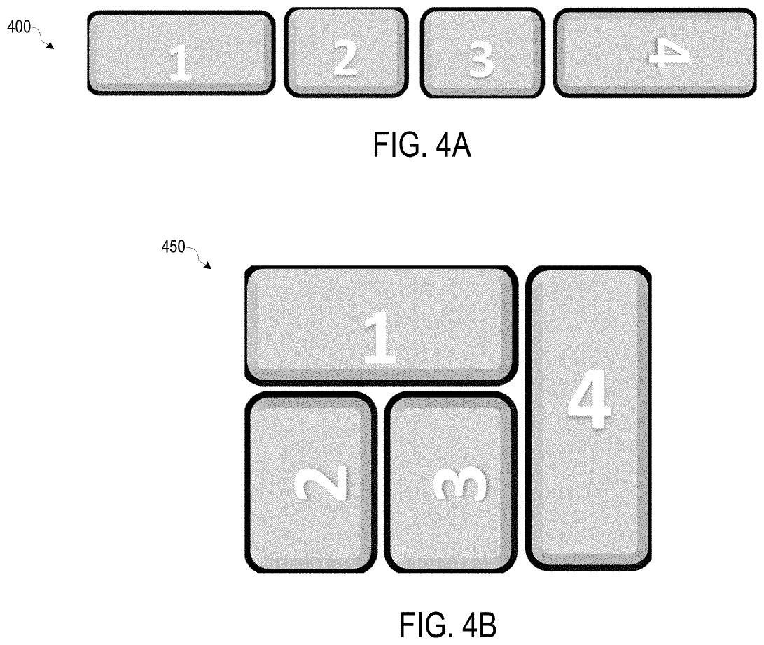

FIGS. 4A and 4B illustrate example results of methods 100 and 200. FIG. 4A illustrates an example plurality 400 of four monitors, 1, 2, 3, and 4, of different sizes and orientations. Plurality 400 represents with a typical operating system may present to a user after connection of each of the four monitors, but without any manipulation to inform the operating system of the actual physical layout of the monitors. As can be seen, the monitors are simply depicted in a linear array.

FIG. 4B illustrates an example plurality 450 of the four monitors following capture and processing, such as with methods 100 and 200. Plurality 450 illustrates the four monitors in their actual physical layout. Plurality 450 would be displayed by an operating system following processing with methods 100 and 200, where the operating system is now aware of the actual position and orientation of each monitor. As can be seen, monitors 2, 3, and 4 are rotated to a portrait position. The overall configuration of plurality 450, as can be seen, resembles that of a large monitor in landscape mode. If so instructed, a computer system receiving plurality 450 could use the four monitors collectively to behave as a single, large display.

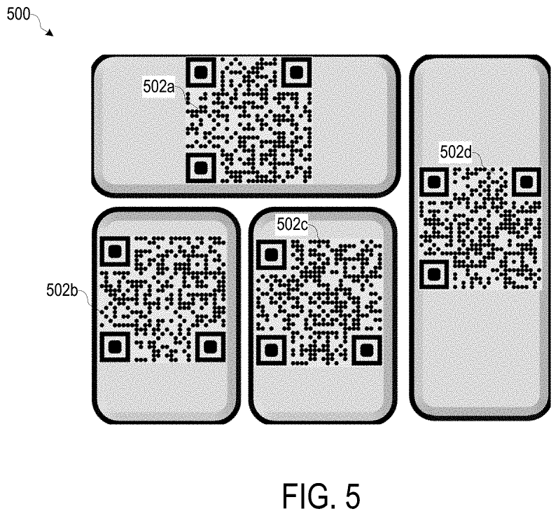

Finally, FIG. 5 illustrates an example plurality of monitors 500 that are in a similar configuration to plurality 450 of FIG. 4B, with each of the monitors displaying a unique identifier, namely, QR codes 502a, 502b, 502c, and 502d. In the illustrated example, each of the unique identifiers are QR codes. As is known, QR codes provide for redundant two-dimensional encoding of information, as well as inherent indication of orientation. By virtue of its specified structure and common markers, QR codes convey their orientation. Thus, display of a QR code on each monitor as a unique identifier inherently conveys that monitor's physical orientation and current orientation setting in the operating system. For example, QR codes 502a and 502d are displayed right side up. An operating system can thus determine that the monitors associated with QR codes 502a and 502d are set to display in their correct modes, namely, landscape for 502a and portrait for 502d. Conversely, QR codes 502b and 502c are each rotated 90 degrees to the left. The operating system can determine that the monitors associated with QR codes 502b and 502c are each physically in a portrait orientation, but that the operating system is incorrectly set to display in landscape mode. This correlates to the initial understanding of the monitor layout in FIG. 4A, of plurality 400. Following processing, the operating system can use the indicated orientation of each QR to switch the monitors displaying QR codes 502b and 502c to portrait mode, so that they display in accordance with their physical orientation.

These QR codes, as noted above, can encode information to varying degrees, depending upon the type of QR that is used. This encoded information, as discussed above, may include various parameters about each QR code's respective monitor, such as resolution, model number, size, color settings, current resolution settings, etc. Alternatively, each QR code may encode a reference such as a URL or key that can allow a receiving computer system to retrieve the relevant monitor parameters from a separate database. It should be understood that QR codes are only one possible way of providing a unique identifier. Other ways of providing a unique identifier, e.g. text, barcodes, two-dimensional codes, or other suitable markers may be employed so long as they can convey any needed information, as discussed above, and can be detected and processed to obtain the needed information.

Still further, while the foregoing describes each code as a unique identifier, in some embodiments, it may be possible to use the same identifier across multiple monitors, and use other aspects to positively identify each monitor's location within the plurality of monitors. For example, there may be sufficient information that can be obtained by processing of the image of the monitors that, in conjunction with a common identifier, a correct physical layout can be determined and provided to the computer system. Each monitor may be of differing sizes and/or orientations or rotations such that it can be distinguished from the other monitors in the physical monitor layout.

FIG. 6 illustrates an example computer device 1500 that may be employed by the apparatuses and/or methods described herein, in accordance with various embodiments. As shown, computer device 1500 may include a number of components, such as one or more processor(s) 1504 (one shown) and at least one communication chip 1506. In various embodiments, the one or more processor(s) 1504 each may include one or more processor cores. In various embodiments, the one or more processor(s) 1504 may include hardware accelerators to complement the one or more processor cores. In various embodiments, the at least one communication chip 1506 may be physically and electrically coupled to the one or more processor(s) 1504. In further implementations, the communication chip 1506 may be part of the one or more processor(s) 1504. In various embodiments, computer device 1500 may include printed circuit board (PCB) 1502. For these embodiments, the one or more processor(s) 1504 and communication chip 1506 may be disposed thereon. In alternate embodiments, the various components may be coupled without the employment of PCB 1502.

Depending on its applications, computer device 1500 may include other components that may be physically and electrically coupled to the PCB 1502. These other components may include, but are not limited to, memory controller 1526, volatile memory (e.g., dynamic random access memory (DRAM) 1520), non-volatile memory such as read only memory (ROM) 1524, flash memory 1522, storage device 1554 (e.g., a hard-disk drive (HDD)), an I/O controller 1541, a digital signal processor (not shown), a crypto processor (not shown), a graphics processor 1530, one or more antennae 1528, a display, a touch screen display 1532, a touch screen controller 1546, a battery 1536, an audio codec (not shown), a video codec (not shown), a global positioning system (GPS) device 1540, a compass 1542, an accelerometer (not shown), a gyroscope (not shown), a speaker 1550, a camera 1552, and a mass storage device (such as hard disk drive, a solid state drive, compact disk (CD), digital versatile disk (DVD)) (not shown), and so forth.

In some embodiments, the one or more processor(s) 1504, flash memory 1522, and/or storage device 1554 may include associated firmware (not shown) storing programming instructions configured to enable computer device 1500, in response to execution of the programming instructions by one or more processor(s) 1504, to practice all or selected aspects of the system 100, process flow 200, and/or method 300, described herein. In various embodiments, these aspects may additionally or alternatively be implemented using hardware separate from the one or more processor(s) 1504, flash memory 1522, or storage device 1554.

The communication chips 1506 may enable wired and/or wireless communications for the transfer of data to and from the computer device 1500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1506 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device 1500 may include a plurality of communication chips 1506. For instance, a first communication chip 1506 may be dedicated to shorter range wireless communications such as Wi-Fi and Bluetooth, and a second communication chip 1506 may be dedicated to longer range wireless communications such as GPS, EDGE, GPRS, CDMA, WiMAX, LTE, Ev-DO, and others.

In various implementations, the computer device 1500 may be a laptop, a netbook, a notebook, an ultrabook, a smartphone, a computer tablet, a personal digital assistant (PDA), a desktop computer, smart glasses, or a server. In further implementations, the computer device 1500 may be any other electronic device that processes data.

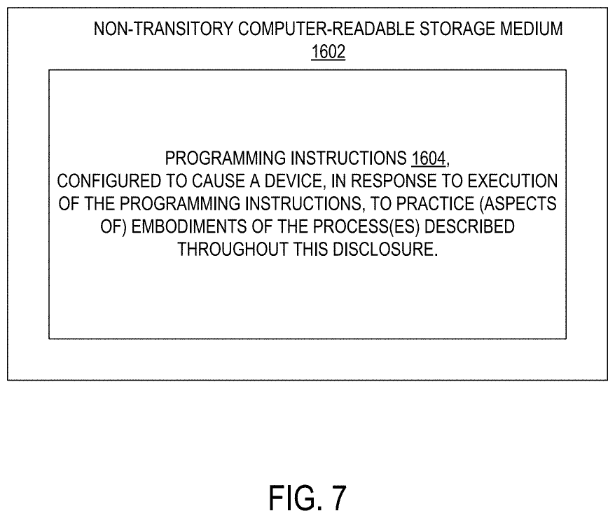

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 7 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 1602 may include a number of programming instructions 1604. Programming instructions 1604 may be configured to enable a device, e.g., computer 1500, in response to execution of the programming instructions, to implement (aspects of) system 100, process flow 200, and/or method 300. In alternate embodiments, programming instructions 1604 may be disposed on multiple computer-readable non-transitory storage media 1602 instead. In still other embodiments, programming instructions 1604 may be disposed on computer-readable transitory storage media 1602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

### EXAMPLES

The following examples pertain to further embodiments:

Example 1 is a method, comprising receiving, by a server, an image of a plurality of monitors connected to a computer system, the plurality of monitors in the image displaying display identifiers; and processing, by the server using the display identifiers, the image to determine a physical layout of the plurality of monitors.

Example 2 includes the subject matter of example 1, or some other example herein, further comprising providing, by the server, the physical layout of the plurality of monitors to the computer system.

Example 3 includes the subject matter of example 1 or 2, or some other example herein, wherein processing the image to determine the physical layout of the plurality of monitors comprises determining, from each display identifiers, the orientation or rotation of the respective monitors of the plurality of monitors.

Example 4 includes the subject matter of any of examples 1-3, or some other example herein, wherein processing the image to determine the physical layout of the plurality of monitors further comprises determining, from the image of the plurality of monitors, the position of the plurality of monitors relative to one another.

Example 5 includes the subject matter of any of examples 1-4, or some other example herein, wherein determining, from the image of the plurality of monitors, the position of the plurality of monitors relative to one another further comprises performing, on the image of the plurality of monitors, an object detection algorithm to detect the size, shape, and position of the plurality of monitors.

Example 6 includes the subject matter of any of examples 1-5, or some other example herein, wherein processing the image to determine the physical layout of the plurality of monitors comprises determining, using an object detection algorithm, the orientation and position of the plurality of monitors.

Example 7 includes the subject matter of any of examples 1-6, or some other example herein, further comprising extracting, from the display identifiers, the resolution, make and model, and/or operating system enumeration number for a display identifier's respective monitor from the plurality of monitors.

Example 8 is a non-transitory computer-readable medium (CRM) comprising instructions that, when executed by an apparatus, cause the apparatus to receive an image of a plurality of monitors, the plurality of monitors in the image displaying display identifiers; process the image to determine a physical layout of the plurality of monitors; and provide the physical layout of the plurality of monitors to the computer system.

Example 9 includes the subject matter of example 8, or some other example herein, wherein the instructions are to further cause the apparatus to determine, from the display identifiers, the orientation or rotation of the monitors of the plurality of monitors.

Example 10 includes the subject matter of example 8 or 9, or some other example herein, wherein the instructions are to further cause the apparatus to determine, from the image of the plurality of monitors, the position of the monitors of the plurality of monitors relative to one another.

Example 11 includes the subject matter of any of examples 8-10, or some other example herein, wherein the instructions are to further cause the apparatus to determine the position of the plurality of monitors relative to one another by performing, on the image of the plurality of monitors, an object detection algorithm to detect the size, shape, and position of the plurality of monitors.

Example 12 includes the subject matter of any of examples 8-11, or some other example herein, wherein the instructions are to further cause the apparatus to determine, with an object detection algorithm, the orientation and position of the plurality of monitors.

Example 13 includes the subject matter of any of examples 8-12, or some other example herein, wherein the instructions are to further cause the apparatus to extract, from the display identifiers, the resolution, make and model, and/or operating system enumeration number for a display identifier's respective monitor from the plurality of monitors.

Example 14 includes the subject matter of any of examples 8-13, or some other example herein, wherein the apparatus is a remote server or a mobile device that is in network communication with the computer system.

Example 15 includes the subject matter of any of examples 8-14, or some other example herein, wherein the apparatus is the computer system, and the instructions are to further cause the computer system to display, upon a monitor of the plurality of monitors, the monitor's respective display identifier.

Example 16 is a system, comprising an image processor to identify, from a single image of a plurality of monitors connected to a computer system, the relative location of the plurality of monitors in the single image, and extract, from the single image, unique identifiers displayed on the plurality of monitors; and a monitor layout generator to determine a physical layout of the plurality of monitors from the relative location of the plurality of monitors and their respective unique identifiers.

Example 17 includes the subject matter of example 16, or some other example herein, further comprising an image generator to generate the unique identifier for of the plurality of monitors, the unique identifiers encoding information about their respective monitors.

Example 18 includes the subject matter of example 16 or 17, or some other example herein, wherein the unique identifiers are QR codes.

Example 19 includes the subject matter of any of examples 16-18, or some other example herein, wherein the image processor identifies the relative location of the plurality of monitors with respect to one another in the single image using object recognition.

Example 20 includes the subject matter of any of examples 16-19, or some other example herein, wherein the monitor layout generator determines the physical layout of the plurality of monitors at least in part from the orientation of the unique identifiers and information encoded into the unique identifiers about a unique identifier's respective monitor.

Example 21 includes the subject matter of any of examples 16-20, or some other example herein, wherein the system comprises a mobile device, and the single image of the plurality of monitors is captured by an image capture device equipped to the mobile device.

Example 22 includes the subject matter of example 21, or some other example herein, wherein the mobile device is in data communication with the computer system, and is adapted to provide the physical layout of the plurality of monitors to the computer system.

Example 23 includes the subject matter of any of examples 1-7, or some other example herein, wherein the display identifiers are unique from one another.

Example 24 includes the subject matter of any of example 1-7 or 23, or some other example herein, further comprising rendering an image for display across the plurality of monitors based on the physical layout of the plurality of monitors.

What is claimed is:

1. A method, comprising:
receiving, by a server, an image of a plurality of monitors connected to a computer system, the plurality of monitors in the image displaying display identifiers; and
processing, by the server using the display identifiers, the image to determine a physical layout of the plurality of monitors.

2. The method of claim 1, further comprising providing, by the server, the physical layout of the plurality of monitors to the computer system.

3. The method of claim 1, wherein processing the image to determine the physical layout of the plurality of monitors comprises determining, from the display identifiers, the orientation of the respective monitors of the plurality of monitors.

4. The method of claim 3, wherein processing the image to determine the physical layout of the plurality of monitors further comprises determining, from the image of the plurality of monitors, the position of the plurality of monitors relative to one another.

5. The method of claim 4, wherein determining, from the image of the plurality of monitors, the position of the plurality of monitors relative to one another further comprises performing, on the image of the plurality of monitors, an object detection algorithm to detect the size, shape, and position of the plurality of monitors.

6. The method of claim 1, wherein processing the image to determine the physical layout of the plurality of monitors comprises determining, using an object detection algorithm, the orientation and position of the plurality of monitors.

7. The method of claim 1, further comprising extracting, from the display identifiers, the resolution, make and model, and/or operating system enumeration number for a display identifier's respective monitor from the plurality of monitors.

8. The method of claim 1, wherein the display identifiers are unique from one another.

9. The method of claim 1, further comprising rendering an image for display across the plurality of monitors based on the physical layout of the plurality of monitors.

10. A non-transitory computer-readable medium (CRM) comprising instructions that, when executed by an apparatus, cause the apparatus to:
receive an image of a plurality of monitors, the plurality of monitors in the image displaying display identifiers;
process the image to determine a physical layout of the plurality of monitors; and
provide the physical layout of the plurality of monitors to the computer system.

11. The CRM of claim 10, wherein the instructions are to further cause the apparatus to determine, from the display identifiers, the orientation or rotation of the monitors of the plurality of monitors.

12. The CRM of claim 11, wherein the instructions are to further cause the apparatus to determine, from the image of the plurality of monitors, the position of the monitors of the plurality of monitors relative to one another.

13. The CRM of claim 12, wherein the instructions are to further cause the apparatus to determine the position of the plurality of monitors relative to one another by performing, on the image of the plurality of monitors, an object detection algorithm to detect the size, shape, and position of the plurality of monitors.

14. The CRM of claim 10, wherein the instructions are to further cause the apparatus to determine, with an object detection algorithm, the orientation and position of the plurality of monitors.

15. The CRM of claim 10, wherein the instructions are to further cause the apparatus to extract, from the display identifiers, the resolution, make and model, and/or operating system enumeration number for a display identifier's respective monitor from the plurality of monitors.

16. The CRM of claim 10, wherein the apparatus is a remote server or a mobile device that is in network communication with the computer system.

17. The CRM of claim 10, wherein the apparatus is the computer system, and the instructions are to further cause the computer system to display, upon a monitor of the plurality of monitors, the monitor's respective display identifier.

18. A system, comprising:
an image processor to:
identify, from a single image of a plurality of monitors connected to a computer system, the relative location of the plurality of monitors in the single image, and
extract, from the single image, unique identifiers displayed on the plurality of monitors; and
a monitor layout generator to determine a physical layout of the plurality of monitors from the relative location of the plurality of monitors and their respective unique identifiers.

19. The system of claim 18, further comprising an image generator to generate the unique identifier for of the plurality of monitors, the unique identifiers encoding information about their respective monitors.

20. The system of claim 19, wherein the unique identifiers are QR codes.

21. The system of claim 18, wherein the image processor identifies the relative location of the plurality of monitors with respect to one another in the single image using object recognition.

22. The system of claim 21, wherein the monitor layout generator determines the physical layout of the plurality of monitors at least in part from the orientation of the unique identifiers and information encoded into the unique identifiers about a unique identifier's respective monitor.

23. The system of claim 18, wherein the system comprises a mobile device, and the single image of the plurality of monitors is captured by an image capture device equipped to the mobile device.

24. The system of claim 23, wherein the mobile device is in data communication with the computer system, and is adapted to provide the physical layout of the plurality of monitors to the computer system.
